(19) United States
(12) Patent Application Publication
(10) Pub. No.: US 2005/0227045 A1
(43) Pub. Date: Oct. 13, 2005

(54) Method for the flame spray coating of surfaces with powder to create the lotus effect

(75) Inventors: Markus Oles, Hattingen (DE); Edwin Nun, Billerbeck (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: CREAVIS Gesellschaft fuer Tech.und Innovation mbH, Marl (DE)

(21) Appl. No.: 10/519,951

(22) PCT Filed: Jun. 25, 2003
(86) PCT No.: PCT/EP03/06681

§ 371 Date: Dec. 29, 2004

(30) Foreign Application Priority Data
Jul. 25, 2002 (DE) 102 33 830.2

(51) Int. Cl. B05D 1/12; B32B 5/16

(52) U.S. Cl. 428/143; 427/180; 428/323

(57) ABSTRACT

A process for producing self-cleaning surfaces by a dry coating process. The process produces self-cleaning surfaces that have elevations formed by particles applied dry to the surface by a modified flame-spraying process. The process can equip textiles and other articles, in particular those having plastic surfaces, with self-cleaning properties.

The present invention relates to a process for producing surfaces with self-cleaning properties by means of a flame powder coating process.

The production of self-cleaning surfaces from which contamination can be removed by water set in motion has been previously described on many occasions. A. A. Abramson in Chimia i Shisn russ. 11, 38, has described, as early as 1982, the roll-off of water droplets on hydrophobic surfaces especially if these have structuring, but without any recognition of self-cleaning. For surfaces to be self cleaning, a specific surface chemistry is required, alongside a suitable structure. A suitable combination of structure and hydrophobic properties makes it possible for even small amounts of water set in motion on the surface to entrain adhering dirt particles and clean the surface (WO 96/04123; U.S. Pat. No. 3,354,022, C. Neinhuis, W. Barthlott, Annals of Botany 79, (1997), 667). One way of obtaining this combination of structure and chemistry is to use a process of embossing within a hydrophobic coating. Injection-molding processes and hot-stamping processes may also be used.

According to EP 0 933 388, the prior art in relation to self-cleaning surfaces is that these self-cleaning surfaces require an aspect ratio >1 and surface energy of less than 20 mN/m. The aspect ratio is defined here as the quotient obtained by dividing the average height of the structure by its average width. The abovementioned criteria are to be found in the nature world, for example in the lotus leaf. The surface of the plant, formed from a hydrophobic waxy material, has elevations separated from one another by a few μm. To a substantial extent, water droplets contact only these peaks. There are many descriptions in the literature of water-repellant surfaces of this type, an example being an article in Langmuir 2000, 16, 5754, by Masashi Miwa et al., according to which contact angle and roll-off angle increase with an increase in the degree of structuring of artificial surfaces formed from Boehmite, applied to a spin-coated layer and then calcined.

Besides this molding of structures using suitable tooling, there has also been development of particulate systems. The Swiss Patent Specification CH-268 258 describes a process in which structured surfaces are generated by applying powders, such as kaolin, talc, clay or silica gel. The powders are secured to the surface by oils and resins based on organosilicon compounds. Recently, particulate systems based on nanoparticles with a highly hydrophobic surface have been developed, as described by way of example in DE 101 29 116, DE 101 38 036, and DE 101 34 477. The linking of the nanoparticles to the substrate takes place either
a) through a carrier layer, or
b) through direct embedding of the particles into the polymer/substrate.

Appropriate processes for case a) have been described. For case b), it has been possible to develop a process which uses a solvent or alcohol. When the solvent is used, the plastic becomes solvated and the nanoparticle becomes embedded into the polymer matrix. With evaporation of the solvent, the plastic hardens again and the nanoparticle has been bonded securely within the polymer matrix. This process, too, has been previously described. If a suspension is used, made from alcohol, which does not solvate the substrate, and from nanoparticles, the suspension is spray-applied to the polymer. Temporary linking of the nanoparticles to the substrate takes place. The precise mechanisms behind this technology are not yet known. However, it is likely that the alcohol acts as an antistat, and reduces the local charge gradients. This process, too, has been previously described, e.g. in DE 102 05 007.

The processes mentioned have also used electrostatic powder-coating methods. In particular, processes of this type were utilized in the production of self-cleaning coatings using a carrier layer, where the powder particles were applied by means of electrostatic coating to the moist adhesive. Another use of this process was directed at dusting the nanoparticles onto a surface which had been moistened (generally alcohol-moistened). The feature common to all of these processes is that the entire workpiece is moistened. This means that very complicated drying has to take place downstream. In particular in the case of textile webs, this represents a problem. In addition, the solvents (alcohols) evaporating represent an environmental problem.

It was therefore an object to develop a process which permits dry-application of the nanoparticles to the workpieces.

Very surprisingly, it has been found that powder-coating processes are generally suitable for this purpose. Surprisingly, it was possible to equip a surface with self-cleaning properties by using modified flame-spraying devices to spray-apply powder to the surface, with no requirement for the powder to be secured to the surface by means of a carrier, adhesive, or solvent.

The present invention provides a process for producing surfaces with self-cleaning properties by applying particles to the surface and securing the particles within the surface, thus forming elevations whose separation is from 20 nm to 100 μm and whose height is from 20 nm to 100 μm, which comprises applying the particles through spray-application of the particles by means of a hot air stream whose temperature softens the material of the surface to be treated to a degree such that at least part of the periphery of the particles can penetrate the material of the surface, and such that the particles which have penetrated, at least to some extent, the material of the surface, are secured within the surface on cooling of the substrate.

The present invention also provides self-cleaning surfaces produced by means of the process of the invention, and particles with a surface of the invention, and also the use of the process of the invention for coating articles exposed to high levels of contamination by dirt and water, in particular for the outdoor sector, ski sports, alpine sports, motor sports, motorcycle sports, motocross sports, sailing sports, textiles for the leisure sector, or for coating technical textiles selected from tenting, awnings, umbrellas, table covers, cabriolet covers, and workwear.

The process of the invention has the advantage that particles for producing self-cleaning surfaces can be applied to surfaces without using solvents. At the same time, excellent securing of the particles to or within the surface takes place, since when the material of the surface hardens the particles are securely anchored therein.

Other advantages of the process of the invention are that it can easily be integrated into existing plants, and, specifically in textile manufacture and textile finishing, permits high web speed. Integration of the process of the invention within the textile industry is possible with particular ease since it is particularly within the textile industry that flame processes have already become established.

The process of the invention for producing surfaces with self-cleaning properties, and also the surfaces of the invention, are described below by way of example, but there is no intention that the invention be restricted thereto. The process is based on the principle of the flame-spraying process. In this technique, which is in fact used for coating plastics, a powder which is introduced with a portion of the combustion air is melted in the flame and is caused by the combustion gases to impact the surface. For the purposes of the present invention, the process is modified in order to use nanoparticles or particles which require a very high temperature before they convert to a liquid phase. The heat of the flame does not melt the powder, but melts the substrate to be treated, or the material at the surface of the substrate, whereupon the nanoparticles become embedded into the surface of the molten substrate, and are secured therein during cooling.

The process of the invention for producing surfaces with self-cleaning properties by applying particles to the surface and securing the particles within the surface, thus forming elevations whose separation is from 20 nm to 100 μm and whose height is from 20 nm to 100 μm comprises applying the particles through spray-application of the particles by means of a hot air stream or a flame. The selection of the temperature of the air stream or of the flame has to be such that no thermal damage occurs to the particles used, but nevertheless such that the action of the flame or air, stream on the material is sufficiently great to heat the surface of the material above its last transition temperature Tg, with the result that the material of the surface to be treated softens to a degree such that at least part of the periphery of the particles can penetrate the material of the surface, and such that the particles which have penetrated, at least to some extent, the material of the surface, are secured within the surface on cooling of the substrate. Depending on the viscosity and material of the substrate, incipient melting, or merely plasticification, of the material has to take place. The necessary degree of softening may easily be determined for the respective material using simple preliminary experiments. The surfaces produced preferably have elevations whose average height is from 50 nm to 10 μm, and/or whose average separation is from 50 nm to 10 μM, and very particularly preferably whose average height is from 50 nm to 4 μm, and/or whose average separation is from 50 nm to 4 μm. Surfaces produced using the process of the invention are very particularly preferably those whose elevations have an average height from 0.25 to 1 μm and an average separation from 0.25 to 1 μm. For the purposes of the present invention, the average separation of the elevations is the separation of the highest elevation of an elevation from the most adjacent highest elevation. If an elevation has the shape of a cone, the tip of the cone is the highest elevation of the elevation. If the elevation is a rectangular parallelepid, the uppermost surface of the rectangular parallelepid is the highest elevation of the elevation.

The process of the invention may preferably be used to equip substrates with a self-cleaning surface, where these have, as surface material, a material selected from thermoplastics, e.g. polyolefins, vinyl polymers, polyamides, polyesters, polyacetals, or polycarbonates, or from low-melting-point metals or alloys selected from tin, lead, Wood's metal, gallium, or soft solder. The substrate itself or the surface may be the surface of a film, of a three-dimensional article, or of a molding, or of a flat fabric, or of a membrane.

The hot air stream temperature needed for the respective material may be generated electrically or by combustion (including catalytic) of combustible gases. Suitable devices may operate using the flame spray gun. However, modified hot air blowers which have a facility for addition of particles to the hot air stream are also suitable. Typical hot air temperatures extend from 35 to 3150° C. Preferred hot air temperatures are in the range from 50 to 1250° C., with preference from 90 to 900° C., and very particularly preferably from 90 to 500° C. It can be advantageous for the temperature generated close to the surface by the hot air stream to be markedly above the glass transition temperature of the surface material. There should be a high degree of local restriction of this temperature, in order to prevent deformation of the surface. Flames of gas burners have proven particularly suitable for generating locally restricted hot air streams.

In order to ensure that the surface temperature of the particles used does not become excessive, these may have been cooled before blowing into the flame or air stream. This procedure also reduces the temperature of the air stream or flame. The surface temperature of the material to be coated may be adjusted not only by way of the air stream temperature or flame temperature, or the separation between the flame or the air stream and the surface, but also by way of the residence time of the surface under the air stream or flame.

The particles may be added to the air stream before or after it is heated. It is preferable for the particles to be added to the air stream before the air stream is heated. If the hot stream is generated by combustion of gases, it can be advantageous to add the particles to at least a portion of the combustion air and/or to at least a portion of the gases for combustion. The particles may added using the suction jet principle. However, it is also possible for the addition of the powder to the air stream or to the substreams needed to generate the air stream to take place in a fluidization chamber.

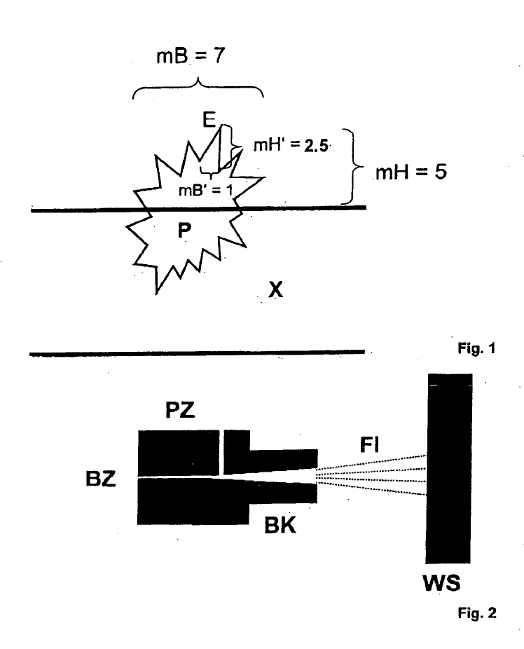

FIG. 2 shows the principle of a flame spray gun. An example of a producer of suitable flame spray guns is the company Baumann Plasma Flame Technik AG in Switzerland.

The penetration depth can be determined as a function of the viscosity of the material of the surface on impact of the particles onto the surface by means of the flow velocity of the hot air stream, and therefore using the velocity of the particles located therein. Examples of typical gas velocities are from 1 000 to 5 000 m/s. However, the particle velocity is usually substantially lower and may be from 20 m/s to 600 m/s, for example. The velocity of the particles prior to impact onto the surface to be treated is preferably from 30 to 200 m/s. The adjustment of the temperature of the air stream and velocity of the air stream or of the particles is preferably such that the extent to which the particles penetrate into the surface is from 10 to 90%, preferably from 20 to 50%, and very particularly preferably from 30 to 40%, of the average particle diameter, and thus that the particles have been securely anchored within the surface once the material has cooled.

The particles used may be those which comprise at least one material selected from silicates, minerals, metal oxides, metal powders, silicas, pigments, and high-temperature-resistant (HT) polymers. The particles may particularly preferably be silicates, doped silicates, minerals, metal oxides, aluminum oxide, silicas, or Aerosils, or pulverulent polymers, e.g. spray-dried and agglomerated emulsions, or cryogenically ground PTFE. It is preferable to use particles which have hydrophobic properties. Silicas are particularly preferably used as hydrophobic particles.

It is preferable to use particles whose average particle diameter is from 0.02 to 100 μm, particularly preferably from 0.01 to 50 μm, and very particularly preferably from 0.1 to 30 μm. However, other suitable particles are those which combine primary particles to give agglomerates or aggregates whose size is from 0.2 to 100 μm.

It can be advantageous for the particles used to have a structured surface. It is preferable to use particles whose surface has an irregular fine structure in the nanometer range, i.e. a structure in the range from 1 to 1 000 nm, preferably from 2 to 750 nm, and particularly preferably from 10 to 100 nm. A fine structure is understood to mean structures whose heights, widths, and separations are within the ranges mentioned. These particles preferably comprise at least one compound selected from fumed silica, precipitated silicas, aluminum oxide, silicon dioxide, fumed and/or doped silicates, and pulverulent high-temperature-resistant polymers. The particles having the irregular slightly fissured structure in the nanometer range preferably have elevations whose aspect ratio in the fine structures is greater than 1, particularly preferably greater than 1.5. The aspect ratio is defined here as the quotient obtained by dividing the maximum height of the elevation by its maximum width. FIG. 1 illustrates diagrammatically this particle shape. The figure shows the surface of a substrate X, which comprises particles P (only one particle being depicted to simplify the illustration). The elevation formed by the particle itself has an aspect ratio of about 0.71, calculated as the quotient obtained from the maximum height of the particle mH, which is 5, since only that portion of the particle which protrudes from the surface of the injection molding X contributes to the elevation, and from the maximum width mB, which in turn is 7. A selected elevation of the elevations E present on the particles by virtue of the fine structure of the particles has an aspect ratio of 2.5, calculated as quotient from the maximum height of the elevation mH′, which is 2.5, and from the maximum width mB′, which in turn is 1.

The hydrophobic properties of the particles may be inherently present by virtue of the material used for the particles, as is the case with polytetrafluorethylene (PTFE), for example. However, it is also possible to use hydrophobic particles which have hydrophobic properties after suitable treatment, e.g. with at least one compound selected from the group consisting of the alkyl silanes, the fluoroalkylsilanes, and the disilazanes. Particularly suitable particles are hydrophobized fumed silicas, known as Aerosils. Examples of hydrophobic particles are Aerosil VPR 411 and Aerosil R 8200. Examples of particles which can be hydrophobized through treatment with perfluoroalkyl silane followed by heat-conditioning are Aeroperl 90/30, Sipernat silica 350, aluminum oxide C, zircon silicate, vanadium-doped or VP Aeroperl P 25/20. These hydrophobized particles can usually be used up to a temperature of 350° C. without difficulty with no substantial impairment of hydrophobic properties.

The particles used, in particular particles whose surface has an irregular fine structure in the nanometer range, are preferably those which comprise at least one compound selected from fumed silica, aluminum oxide, silicon oxide, and pulverulent HT polymers, and metals. It can be advantageous for the particles used to have hydrophobic properties. Very particularly suitable-particles, inter alia, are hydrophobized fumed silicas, known as Aerosils.

It can be advantageous to use particles which have hydrophobic properties. The hydrophobic properties of the particles may be inherently present by virtue of the material used for the particles. However, it is also possible to use hydrophobized particles which have hydrophobic properties as a result of treatment with at least one compound selected from the group consisting of the alkyl silanes, perfluoroalkyl silanes, paraffins, waxes, fatty esters, functionalized long-chain alkane derivatives, and alkyl disilazanes.

It can be advantageous to hydrophobize (again) subsequently the surfaces which have been equipped with the surface structure. This may be achieved by treating the surfaces with the compounds given for hydrophobizing the particles.

The process of the invention can produce self-cleaning surfaces which preferably have elevations formed from particles, where the elevations have a separation of from 20 nm to 100 μm and a height of from 20 nm to 100 μm.

The surfaces of the invention preferably have at least one layer having elevations whose average height is from 20 nm to 25 μm and whose average separation is from 20 nm to 25 μm, preferably whose average height is from 50 nm to 10 μm and/or whose average separation is from 50 nm to 10 μm, and very particularly preferably whose average height is from 50 nm to 4 μm and/or whose average separation is from 50 nm to 4 μm. The surfaces of the invention very particularly preferably have elevations whose average height is from 0.25 to 1 μm and whose average separation is from 0.25 to 1 μm. For the purposes of the present invention, the average separation of the elevations is the separation between the highest elevation of an elevation and the most adjacent highest elevation. If an elevation has the shape of a cone, the tip of the cone is the highest elevation of the elevation. If the elevation is a rectangular parallelepid, the uppermost surface of the rectangular parallelepid is the highest elevation of the elevation.

For the purposes of the present invention, a layer of elevations or of particles is a surface collection of particles which form elevations. The layer may have been formed in such a way that the surface comprises exclusively particles, almost exclusively particles, or else particles whose separation is from 0 to 10 particle diameters, in particular from 0 to 3 particle diameters.

The surfaces of the invention with self-cleaning properties preferably have an aspect ratio greater than 0.15 for the elevations. The elevations formed by the particles themselves preferably have an aspect ratio of from 0.3 to 0.9, particularly preferably from 0.5 to 0.8. The aspect ratio is defined here as the quotient obtained by dividing the maximum height of the structure of the elevations by the maximum width.

A feature of the surfaces of the invention, which have self-cleaning properties and surface structures with elevations is that the surfaces are materials which, when exposed to heat, are capable of softening or of incipient melting, and which harden on cooling, and into which the particles have been directly bonded or anchored, and have not been linked via carrier systems or the like.

The manner of linking or anchoring the particles to the surface is that on impact of the air stream the particles are, at least to some extent, pressed into the material which has undergone softening or incipient melting. In order to achieve the aspect ratios mentioned it is advantageous for at least a portion of the particles, preferably more than 50% of the particles, to be pressed into the surface of the material only to the extent of 90% of their diameter. The surface therefore preferably comprises particles which have been anchored within the surface by using from 10 to 90%, preferably from 20 to 50%, and very particularly preferably from 30 to 40%, of their average particle diameter, so that portions of their inherently fissured surface still protrude from the surface.

This method ensures that the elevations which are formed by the particles themselves have a sufficiently large aspect ratio, preferably at least 0.15. This method also provides very durable bonding of the securely bonded particles to the surface of the substrate. The aspect ratio is defined here as the ratio of maximum height to maximum width of the elevations. A particle assumed to be ideally spherical, 70% of which protrudes from the surface of the injection molding, has an aspect ratio of 0.7 by this definition. It should be explicitly indicated that the particles of the invention do not have to have spherical shape.

The wetting of bodies, and therefore the property of self-cleaning, can be described via the contact angle formed by a water droplet with the surface. An angle of contact of 0 degree here means complete wetting of the surface. The static angle of contact is generally measured using equipment in which the angle of contact is determined optically. On smooth hydrophobic surfaces, the static contact angles measured are usually below 125°. The present self-cleaning surfaces have static contact angles which are preferably greater than 130°, with preference greater than 140°, and very particularly preferably greater than 145°. In addition, it has been found that a surface has good self-cleaning properties only when it exhibits a difference of not more than 10° between advancing and receding angle, and for this reason surfaces of the invention preferably have a difference of less than 10°, preferably less than 5°, and very particularly preferably less than 4°, between advancing and receding angle. To determine the advancing angle, a water droplet is placed on the surface by means of a canular, and the droplet is enlarged on the surface by adding water through the canular. During enlargement, the margin of the droplet glides over the surface, and the contact angle determined is the advancing angle. The receding angle is measured on the same droplet, but water is removed from the droplet through the canular, and the contact angle is measured during reduction of the size of the droplet. The difference between the two angles is termed hystersis. The smaller the difference, the smaller the interaction of the water droplet with the surface of the substrate, and therefore the better the lotus effect.

The surface of the invention may be a surface of a textile, of a film, of a three-dimensional article, of a truck tarpaulin, or of a membrane.

Examples of the use of the process of the invention are the coating of articles which are exposed to high levels of contamination by dirt or water, in particular for the outdoor sector, ski sports, alpine sports, motor sports, motorcycle sports, motocross sports, sailing sports, textiles for the leisure sector, and also the coating of technical textiles selected from the group consisting of tenting, awnings, umbrellas, table covers, cabriolet covers, and workwear.

Examples of articles with a surface of the invention are films, consumer articles, sports items, textiles, clothing, and roof underfelt.

The process of the invention is described in more detail using FIGS. 1 to 4, but with no intention that the invention be restricted to these embodiments.

FIG. 1 gives an illustrative diagram of the difference between the elevations formed by the particles and the elevations formed by the fine structure. The figure shows the surface of a substrate X which has particles P (only one particle being depicted to simplify the illustration). The elevation formed by the particle itself has an aspect ratio of about 0.71, calculated as the quotient obtained from the maximum height of the particle mH, which is 5, since only that portion of the particle which protrudes from the surface of the injection molding X contributes to the elevation, and from the maximum width mB, which in turn is 7. A selected elevation of the elevations E present on the particles by virtue of the fine structure of the particles has an aspect ratio of 2.5, calculated as quotient from the maximum height of the elevation mH′, which is 2.5, and from the maximum width mB′, which in turn is 1.

FIG. 2 is a diagram of a flame spray head. This has a combustion gas feed BZ, a combustion chamber BK, and a particle feed PZ. The flame Fl emerges from the combustion chamber and comprises particles. The particles present in the flame are carried by the air stream of the flame to the surface of the material WS, where they become secured after cooling.

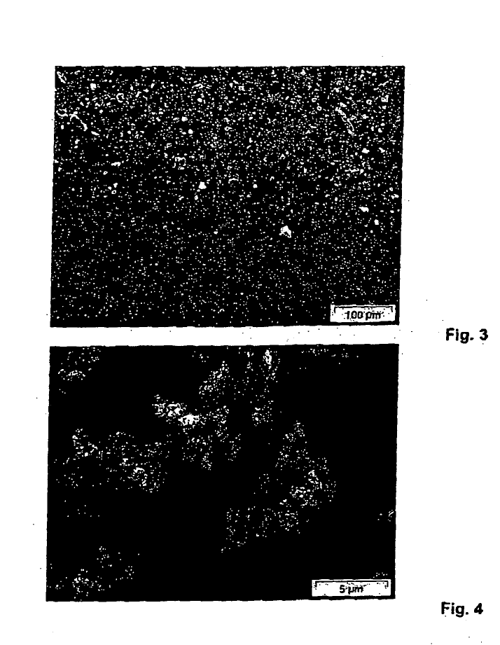

FIGS. 3 and 4 show scanning electron micrographs (SEMs) of a polypropylene sheet coated as in example 1, at various magnifications. The length of the scale indicator is 100 μm in FIG. 3 and 5 μm in FIG. 4.

The process of the invention is described by way of example using the examples below, but there is no intention that the invention be restricted thereto.

### EXAMPLE 1

A propylene sheet with dimensions 0.1 m×0.1 m×0.005 m was treated using a propane flame. The particles used comprise Aerosil R 8200 from the company Degussa AG. The flame temperature was from 500 to 1 200° C. The air stream velocity for particle transport was about 120 m/s. The manner of the treatment was such that first the flame was directed for about 5 seconds onto the polypropylene sheet. After these 5 seconds, particles (10 g/s) were added to the flame for 2 seconds. After this treatment, the flame was removed, and the sheet was cooled to room temperature and studied.

The sheet obtained had an almost coherent particle coating, where from 30 to 50% of the periphery of the particles had been anchored within the surface. FIGS. 3 and 4 show SEMs of the resultant treated polypropylene sheet at different resolution. The behavior of the treated polypropylene sheet was then studied. The treated sheet exhibited a very good lotus effect. Run-off of water droplets was very good. The run-off angle, i.e. that angle to the horizontal at which a water droplet rolls off spontaneously, was 5° for a 60 μl water droplet, and the advancing angle for a water droplet pipetted onto the surface was 131.30, and the receding angle was 120.6°.

1-16. (canceled)

17. A process for producing surfaces with self-cleaning properties by applying particles to the surface and securing the particles within the surface, thus forming elevations whose separation is from 20 nm to 100 μm and whose height is from 20 nm to 100 μm, the process comprising:
applying the particles through spray-application of the particles by a hot air stream whose temperature softens a material of the surface to be treated to a degree such that at least part of a periphery of the particles can penetrate the material of the surface, and such that the particles that have penetrated, at least to some extent, the material of the surface are secured within the surface on cooling of the substrate.

18. The process as claimed in claim 17, wherein the material of the surface is selected from thermoplastics, or from low-melting-point metals or alloys selected from tin, lead, Wood's metal, gallium, or soft solder.

19. The process as claimed in claim 17, wherein the surface is the surface of a film, of a three-dimensional article, or of a molding.

20. The process as claimed in claim 17, wherein the hot air stream is produced electrically or by combustion of combustible gases.

21. The process as claimed in claim 17, wherein the particles are added to the air stream before or after the air stream is heated.

22. The process as claimed in claim 17, wherein the particles have a surface with an irregular fine structure in the nanometer range.

23. The process as claimed in claim 17, wherein the particles have an average particle diameter from 0.02 to 100 μm.

24. The process as claimed in claim 23, wherein the particles have an average particle diameter from 0.1 to 30 μm.

25. The process as claimed in claim 17, wherein the particles are selected from silicates, minerals, metals oxides, metal powders, silicas, pigments, HT polymers.

26. The process as claimed in claim 17, wherein the particles are selected from fumed silicas, precipitated silicas, aluminum oxide, silicon dioxide, doped silicates, and pulverulent HT polymers.

27. The process as claimed in claim 17, wherein the particles are equipped with hydrophobic properties through treatment with at least one compound selected from the group consisting of alkyl silanes, fluoroalkyl silanes, and disilazanes.

28. A self-cleaning surface produced by a process as claimed in claim 17.

29. The surface as claimed in claim 28, which has elevations formed from particles, wherein the elevations have a separation from 20 μm to 100 μm and a height of from 20 nm to 100 μm.

30. The surface as claimed in claim 28, which is the surface of a textile, of a film, of a three-dimensional article, of a molding.

31. The use of the process as claimed in claim 17 for coating of articles exposed to high levels of contamination by dirt and water, in particular for outdoor sector, ski sports, alpine sports, motor sports, motorcycle sports, motocross sports, sailing sports, textiles for leisure sector, or for coating technical textiles selected from tenting, awnings, umbrellas, table covers, cabriolet covers, and workwear.

32. An article with a surface as claimed in 28, which encompasses films, consumer articles, sports items, textiles, clothing, and moldings.
